(19) United States
(12) Patent Application Publication
(10) Pub. No.: US 2026/0260820 A1
(43) Pub. Date: Sep. 3, 2026

(54) MULTILAYER ELECTRONIC COMPONENT

(71) Applicant: SAMSUNG ELECTRO-MECHANICS CO., LTD., Suwon-si (KR)

(72) Inventors: Gi Sub Lee, Suwon-si (KR); Ji Yun An, Suwon-si (KR); Ah Young Lee, Suwon-si (KR); Ju Yeon Cho, Suwon-si (KR); Won Hyo Joo, Suwon-si (KR)

(73) Assignee: SAMSUNG ELECTRO-MECHANICS CO., LTD., Suwon-si (KR)

(21) Appl. No.: 19/443,649

(22) Filed: Jan. 8, 2026

(30) Foreign Application Priority Data
Feb. 28, 2025 (KR) 10-2025-0026665

(51) Int. Cl. H01G 4/30; H01G 4/012; H01G 4/12

(52) U.S. Cl. CPC H01G 4/30; H01G 4/012; H01G 4/1227; H01G 4/1245

(57) ABSTRACT

A multilayer electronic component includes a body including a dielectric layer and internal electrodes alternately disposed with the dielectric layer; and external electrodes disposed on the body, wherein the dielectric layer includes a central portion spaced apart from the internal electrode and including a first dielectric grain, and interfacial portions disposed between the internal electrode and the central portion and including a second dielectric grain, and wherein an average size of the first dielectric grain is Gs1, an average size of the second dielectric grain is Gs2, the number of moles of Gd based on 100 moles of Ti in the central portion is defined as Mgd1, and the number of moles of Gd based on 100 moles of Ti in the interfacial portion is Mgd2, Gs2/Gs1<1, Mgd1/Mgd2<1, and 4.0≤Mgd2≤25.0 are satisfied.

### CROSS-REFERENCE TO RELATED APPLICATION(S)

The application claims benefit of priority to Korean Patent Application No. 10-2025-0026665 filed on Feb. 28, 2025 in the Korean Intellectual Property Office, the disclosure of which is incorporated herein by reference in its entirety.

### BACKGROUND

### 1. Field

The present disclosure relates to a multilayer electronic component.

### 2. Description of Related Art

A multilayer ceramic component (MLCC), a multilayer electronic component, may be a chip condenser mounted on the printed circuit boards of various electronic products including image display devices such as a liquid crystal display (LCD) and a plasma display panel (PDF), a computer, a smartphone, a mobile phone, or the like, and charging or discharging electricity therein or therefrom.

Such a multilayer ceramic capacitor may be used as a component of various electronic devices, since a multilayer ceramic capacitor may have a small size and high capacitance and may be easily mounted. As various electronic devices such as a computer and a mobile device have been designed to have a reduced size and higher output, demand for miniaturization and/or higher capacity for a multilayer ceramic capacitor has increased.

As the application environments for a multilayer ceramic capacitor has been diversified, reliability at high voltages has also been necessary.

An MLCC used in a high-voltage environment may be referred to as a high-voltage MLCC and may have a rated voltage of 250 V or higher. Because a high-voltage MLCC have significantly higher rated voltages than a standard MLCC, when an electric field is applied, cracks, reduced moisture resistance reliability, and reduced breakdown voltage may occur due to electrostriction.

### SUMMARY

An embodiment of the present disclosure is to provide a multilayer electronic component that may have improved reliability.

An embodiment of the present disclosure is to provide a multilayer electronic component that may suppress electrostriction.

An embodiment of the present disclosure is to provide a multilayer electronic component that may secure high capacitance.

According to an embodiment of the present disclosure, a multilayer electronic component includes a body including a dielectric layer and internal electrodes alternately disposed with the dielectric layer; and external electrodes disposed on the body. The dielectric layer includes a central portion spaced apart from the internal electrode and including a first dielectric grain, and interfacial portions disposed between the internal electrode and the central portion and including a second dielectric grain, and wherein an average size of the first dielectric grain is Gs1, an average size of the second dielectric grain is Gs2, the number of moles of Gd based on 100 moles of Ti in the central portion is Mgd1, and the number of moles of Gd based on 100 moles of Ti in the interfacial portion is Mgd2, Gs2/Gs1<1, Mgd1/Mgd2<1, and 4.0≤Mgd2≤25.0 are satisfied.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is a cross-sectional diagram taken along line I-I′in FIG. 1;

FIG. 3 is a cross-sectional diagram taken along line II-II′ in FIG. 1;

FIG. 4 is an exploded diagram illustrating a body according to an embodiment of the present disclosure;

FIG. 5 is an enlarged diagram illustrating region K1 in FIG. 2;

FIG. 6 is a diagram corresponding to FIG. 5 according to another embodiment of the present disclosure; and

FIG. 7 is a diagram corresponding to FIG. 5 according to another embodiment of the present disclosure.

### DETAILED DESCRIPTION

Hereinafter, some embodiments of the present disclosure will be described as below with reference to the accompanying drawings.

The embodiments of the present disclosure may be modified in various different forms, and the scope of the present disclosure is not limited to the embodiments described below. Also, the embodiments of the present disclosure are provided to more fully describe the present disclosure to those skilled in the art. Accordingly, the shapes and sizes of elements in the drawings may be exaggerated for clarity, and elements indicated by the same reference numerals in the drawings are identical elements.

In the drawings, to clearly describe the present disclosure in the drawings, irrelevant parts may be omitted, and the size and thickness of each component in the drawings have been arbitrarily indicated for ease of description, and thus, the present disclosure is not necessarily limited thereto. Also, the terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the X direction may be the first direction, the lamination direction or the thickness T direction, the Y direction may be the second direction or the length L direction, and the Z direction may be the third direction or the width W direction.

### Multilayer Electronic Component

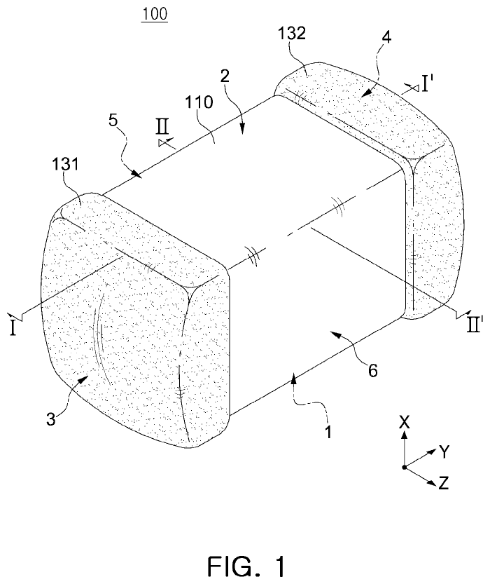

FIG. 1 is a perspective diagram illustrating a multilayer electronic component according to an embodiment.

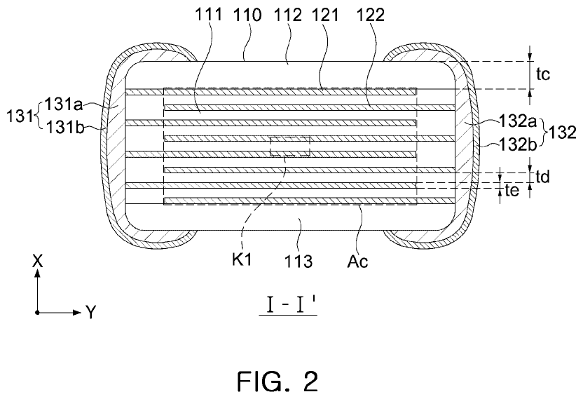

FIG. 2 is a cross-sectional diagram taken along line I-I′ in FIG. 1.

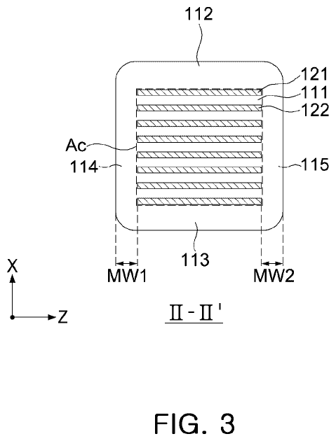

FIG. 3 is a cross-sectional diagram taken along line II-II′ in FIG. 1.

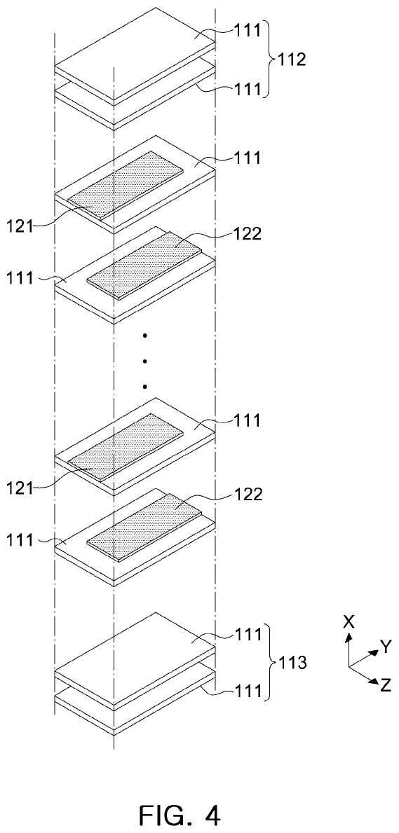

FIG. 4 is an exploded diagram illustrating a body according to an embodiment.

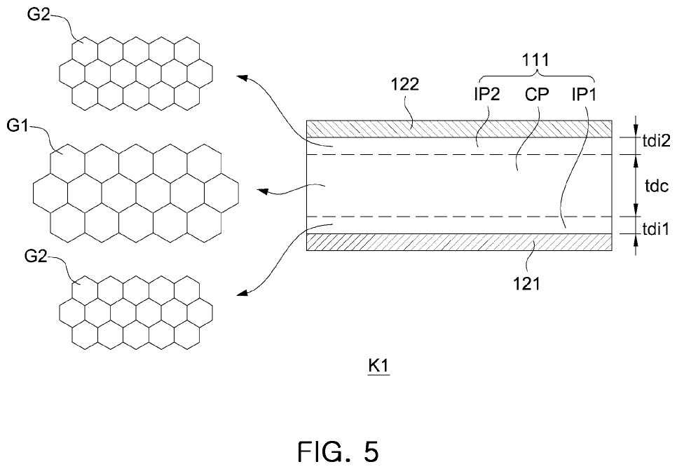

FIG. 5 is an enlarged diagram illustrating region K1 in FIG. 2.

Hereinafter, a multilayer electronic component 100 according to an embodiment of the present disclosure will be described in detail with reference to FIGS. 1 to 5. Also, a multilayer ceramic capacitor (hereinafter referred to as “MLCC”) is described as an example of the multilayer electronic component, but an embodiment thereof is not limited thereto, and may be applied to various multilayer electronic components using a ceramic material, such as an inductor, piezoelectric element, varistor, or thermistor.

A multilayer electronic component according to an embodiment of the present disclosure may include a body 110 including a dielectric layer 111 and internal electrodes 121 and 122 alternately disposed with the dielectric layer 111; and external electrodes 131 and 132 disposed on the body 110, wherein the dielectric layer 111 may include a central portion CP spaced apart from the internal electrode and including a first dielectric grain G1, and interfacial portions IP1 and IP2 disposed between the internal electrode and the central portion and including a second dielectric grain, and wherein an average size of the first dielectric grain is Gs1, an average size of the second dielectric grain is Gs2, the number of moles of Gd based on 100 moles of Ti in the central portion is Mgd1, and the number of moles of Gd based on 100 moles of Ti in the interfacial portion is Mgd2, Gs2/Gs1<1, Mgd1/Mgd2<1, and 4.0≤Mgd2≤25.0 are satisfied.

When adding Gd to the dielectric layer, electrostriction may be suppressed by lowering a dielectric constant, but capacitance of the multilayer ceramic capacitor may be degraded.

According to an embodiment of the present disclosure, when increasing the Gd content of the interfacial portions IP1 and IP2 as compared to the central portion CP and reducing the average dielectric grain size, the capacitance reduction caused by adding Gd may be suppressed, and electrostriction may also be suppressed, thereby improving reliability of the multilayer electronic component 100.

In the description below, each of the components included in the multilayer electronic component 100 according to an embodiment of the present disclosure will be described.

In the body 110, the dielectric layers 111 and the internal electrodes 121 and 122 may be alternately laminated.

The shape of the body 110 may not be limited to any particular shape, but as illustrated, the body 110 may have a hexahedral shape or a shape similar to a hexahedral shape. Due to reduction of ceramic powder particles included in the body 110 during a firing process or polishing of corners, the body 110 may not have an exactly hexahedral shape formed by linear lines but may have a substantially hexahedral shape.

The body 110 may have first and second surfaces 1 and 2 opposing each other in the first direction, third and fourth surfaces 3 and 4 connected to the first and second surfaces 1 and 2 and opposing in the second direction, and fifth and sixth surfaces 5 and 6 connected to the first and second surfaces 1 and 2 and the third and fourth surfaces 3 and 4 and opposing each other in the third direction.

As the margin region in which the internal electrodes 121 and 122 are not disposed overlaps on the dielectric layer 111, a difference in the thicknesses of the internal electrodes 121 and 122 may occur, such that the corner connecting the first surface and the third to fifth surfaces and/or the corner connecting the second surface and the third to fifth surfaces may have a shape reduced toward the center in the first direction of the body 110 when viewed from the first surface or the second surface. Alternatively, due to the reduction behavior during the process of sintering the body, the corner connecting the first surface 1 and the third to sixth surfaces 3, 4, 5, and 6 and/or the corner connecting the second surface 2 and the third to sixth surfaces 3, 4, 5, and 6 may have a shape reduced toward the center in the first direction of the body 110 when viewed from the first surface or the second surface. Alternatively, to prevent chipping defects, the corners connecting each surface of the body 110 may have a rounded shape through performing a separate process, such that each of the corners connecting the first surface and the third to sixth surfaces and/or the corners connecting the second surface and the third to sixth surfaces may have a rounded shape.

To suppress the difference caused by the internal electrodes 121 and 122, when the internal electrodes are cut such that the internal electrodes are exposed to the fifth and sixth surfaces 5 and 6 of the body after lamination, and when side margin portions 114 and 115 are formed by laminating a dielectric layer or two or more dielectric layers in the third direction (width direction) on both side surfaces of the capacitance formation portion Ac, the portion connecting the first surface and the fifth and sixth surfaces and the portion connecting the second surface and the fifth and sixth surfaces may not have a reduced shape.

The plurality of dielectric layers 111 forming the body 110 may be in a fired state, and boundaries between adjacent dielectric layers 111 may be integrated with each other such that boundaries therebetween may not be distinct without using a scanning electron microscope (SEM). It may not be necessary to specifically limit the number of laminates of the dielectric layer, and the number of laminates may be determined by considering the size of the multilayer electronic component. For example, the body may be formed by laminating 400 or more layers of the dielectric layer.

Referring to FIG. 5, the dielectric layer 111 include the central portion CP spaced apart from the internal electrodes 121 and 122 and including the first dielectric grain G1, and the interfacial portions IP1 and IP2 disposed between the internal electrodes 121 and 122 and the central portion CP and including the second dielectric grain G2.

Also, when the average size of the first dielectric grain G1 is Gs1, the average size of the second dielectric grain G2 is Gs2, the number of moles of Gd based on 100 moles of Ti in the central portion CP is Mgd1, and the number of moles of Gd based on 100 moles of Ti in the interfacial portions IP1 and IP2 is Mgd2, Gs2/Gs1<1, Mgd1/Mgd2<1, and 4.0≤Mgd2≤25.0 may be satisfied. Accordingly, electrostriction may be suppressed and capacitance degradation due to addition of Gd may be suppressed.

When the average size Gs1 of the first dielectric grain is less than the average size Gs2 of the second dielectric grain, it may be difficult to suppress electrostriction.

When Mgd1 is equal to or greater than Mgd2, capacitance may degrade. For example, Mgd1 may be 2.0 or less. Also, the central portion CP may not necessarily include Gd, and may not include Gd, and accordingly, Mgd1 may be 0.

When Mgd2 is less than 4.0, the effect of suppressing electrostrictive expansion of the central portion CP may be insufficient. When Mgd2 exceeds 25.0, capacitance may be degraded. Accordingly, it may be preferable to satisfy 4.0≤Mgd2≤25.0, and more preferably, 5.0≤Mgd2≤10.0.

In an embodiment, Gs1 and Gs2 may satisfy Gs2/Gs1≥0.5. This is because when the grain size difference increases excessively, other side effects may occur.

The specific ranges of Gs1 and Gs2 are not limited to any particular example.

For example, in an embodiment, Gs1 may be 300 nm or more and 700 nm or less, and Gs2 may be 150 nm or more and 600 nm or less. Accordingly, the effect of capacitance reduction and electrostriction suppression in the present disclosure may be enhanced.

In an embodiment, Gs1 and Gs2 may satisfy Gs1-Gs2≤100 nm. This is because other side effects may occur when the difference in grain size increases excessively.

The average size Gs1 of the first dielectric grain, the average size Gs2 of the second dielectric grain, the number of moles Mgd1 of Gd based on 100 moles of Ti in the central portion, and the number of moles Mgd2 of Gd based on 100 moles of Ti in the interfacial portion may be measured from images of the cross-sectional surface in the first and second directions of the body 110, observed using a scanning electron microscope-energy dispersive X-ray spectrometer (SEM-EDS), a transmission electron microscope-energy dispersive X-ray spectrometer (TEM-EDS), a scanning transmission electron microscope-energy dispersive X-ray spectrometer (STEM-EDS), or a field emission-scanning electron microscope-energy dispersive X-ray spectrometer (FE-SEM-EDS).

More specifically, the cross-sectional surfaces in the first and second-direction of the multilayer electronic component 100 may be exposed by polishing to the ½ point in the third direction. Subsequently, using FE-SEM-EDS (acceleration voltage: 2 kV, magnification: 50,000×), the average size of dielectric grains in the interfacial and central portions of the dielectric layer disposed in the central portion in the first direction of the capacitance formation portion Ac may be measured. As the size of dielectric grains changes rapidly at the boundary between the interfacial and central portions, the interfacial and central portions may be easily distinguished in the SEM scanned image. The size of the dielectric grains may be the equivalent diameter of a circle measured using image analysis software (ImageJ). The average sizes of 30 or more dielectric grains in each of the interfacial and central portions may be Gs1 and Gs2.

Also, the content (mol %) of Gd and Ti in the interfacial and central portions may be measured. The number of moles of Gd based on 100 moles of Ti in the interfacial and central portions may be calculated, respectively, thereby obtaining Mgd1 and Mgd2.

By selecting 10 dielectric layers disposed in the upper, central, and lower portions in the first direction of the capacitance formation portion Ac, Gs1, Gs2, Mgd1, and Mgd2 may be calculated from 30 dielectric layers, and the average of the values may be calculated to generalize Gs1, Gs2, Mgd1, and Mgd2.

In an embodiment, the internal electrodes 121 and 122 may include a first internal electrode 121 and a second internal electrode 122, alternately disposed with the dielectric layer 111 therebetween. The interfacial portions IP1 and IP2 may include a first interfacial portion IP1 disposed between the central portion CP and the first internal electrode 121, and a second interfacial portion IP2 disposed between the central portion CP and the second internal electrode 122.

In an embodiment, when the average thickness of the first interfacial portion IP1 is tdi1, the average thickness of the second interfacial portion IP2 is tdi2, and the average thickness of the central portion CP is tdc, tdi1/tdc≤0.2 and tdi2/tdc≤0.2 may be satisfied. When tdi1/tdc exceeds 0.2 or tdi2/tdc exceeds 0.2, the effect of suppressing the reduction of capacitance in the embodiment may be insufficient.

The specific ranges of tdi1, tdi2, and tdc may need not be specifically limited.

For example, in an embodiment, each of tdi1 and tdi2 may be 200 nm or more and 500 nm or less.

In an embodiment, tdc may be 1000 nm or more.

In an embodiment, the sum of tdi1, tdi2, and tdc may be 1.4 μm or more and 10.0 μm or less. Here, the sum of tdi1, tdi2, and tdc may indicate the average thickness td of the dielectric layer.

Here, tdi1, tdi2, and tdc may indicate the thickness in the first direction. tdi1, tdi2, and tdc may be measured by scanning the cross-sectional surface in the first and second directions of the body 110 using a scanning electron microscope (SEM) at 10,000× magnification. The thicknesses of the first interfacial portion IP1, the second interfacial portion IP2, and the central portion CP may be measured at 30 points spaced by an equal distance in the second direction, thereby measuring the average values thereof. The 30 points at equal distances may be designated in the capacitance formation portion Ac, which will be described later. Also, by extending the average value measurement to ten dielectric layers 111, tdi1, tdi2, and tdc may be further generalized.

In an embodiment, the dielectric constants of the interfacial portions IP1 and IP2 may be 1500 or less, and the dielectric constant of the central portion CP may be 2000 or more. Accordingly, the effect of suppressing capacitance degradation and electrostriction in the embodiment may be improved.

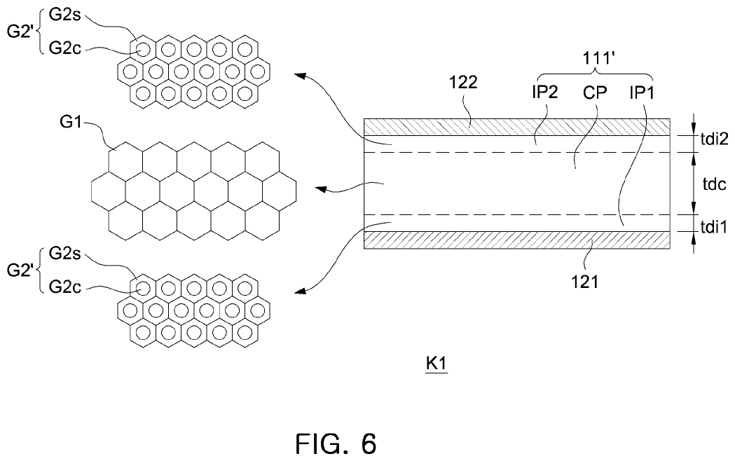

Referring to FIG. 6, the second dielectric grain G2′ included in the interfacial portions IP1 and IP2 of the dielectric layer 111′ may have a core-shell structure, including a core G2c and a shell G2s surrounding at least a portion of the core G2c. In this case, the atomic percentage of the Gd content included in the shell G2s may be higher than the atomic percentage of the Gd content included in core G2c. In this case, the first dielectric grain G1 included in the central portion CP may not have a core-shell structure.

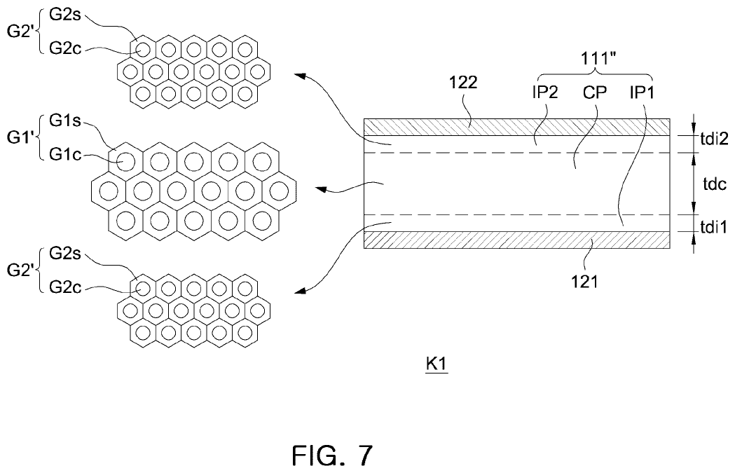

However, an embodiment thereof is not limited thereto, and as illustrated in FIG. 7, both the first dielectric grain G1′ and the second dielectric grain G2′ included in the dielectric layer 111″ may have a core-shell structure. Referring to FIG. 7, the first dielectric grain G1′ included in the central portion CP of the dielectric layer 111′ may also have a core-shell structure including a core G1c and a shell G1s surrounding at least a portion of the core G1c. In this case, the atomic percentage of the Gd content included in the shell G1s may be higher than the atomic percentage of the Gd content included in the shell G1s.

The method for forming the dielectric layer 111 is not limited to any particular example.

For example, a ceramic green sheet may be prepared by applying a ceramic slurry including an organic solvent and a binder onto a carrier film, such that the interfacial portion of the ceramic sheet may have a higher Gd content than that of the central portion. Thereafter, a dielectric layer may be formed by sintering the ceramic green sheet.

The ceramic powder is not limited to any particular example as long as sufficient electrostatic capacitance may be obtained. For example, barium titanate (BaTiO₃) powder may be used as the ceramic powder. For a more specific example, the ceramic powder may include one or more selected from the group of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) and Ba(Ti_{1-y}Zr_{y})O₃ (0<y<1).

Accordingly, in an embodiment, the dielectric layer 111 may include one or more selected from the group of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) and Ba(Ti_{1-y}Zr_{y})O₃ (0<y<1) as a main component. Here, the main component may indicate that the number of moles of the components other than the main component may be 30 moles or less based on 100 moles of the main component.

The body 110 may include a capacitance formation portion Ac forming capacitance including the first internal electrode 121 and the second internal electrode 122 disposed in the body 110 and opposing each other with the dielectric layer 111 therebetween, and cover portions 112 and 113 formed in upper and lower portions in the first direction of the capacitance formation portion Ac.

Also, the capacitance formation portion Ac may contribute to forming the capacitance of the capacitor, and may be formed by repeatedly laminating the plurality of first and second internal electrodes 121 and 122 with the dielectric layer 111 interposed therebetween.

The cover portions 112 and 113 may include an upper cover portion 112 disposed on an upper portion in the first direction of the capacitance formation portion Ac and a lower cover portion 113 disposed on a lower portion in the first direction of the capacitance formation portion Ac.

The upper cover portions 112 and the lower cover portions 113 may be formed by laminating a single dielectric layer or two or more dielectric layers on the upper and lower surfaces of the capacitance formation portion Ac in the thickness direction, respectively, and may prevent damages to the internal electrode due to physical or chemical stress.

The upper cover portions 112 and the lower cover portions 113 may not include an internal electrode and may include the same material as that of the dielectric layer 111.

That is, the upper cover portions 112 and the lower cover portions 113 may include a ceramic material, for example, a barium titanate (BaTiO₃) ceramic material.

The thickness of the cover portions 112 and 113 may not be limited to any particular example. For example, a thickness tc of the cover portions 112 and 113 may be 100 μm or less.

The average thickness tc of the cover portions 112 and 113 may indicate the size in the first direction, and may be an average value of the sizes in the first direction of the cover portions 112 and 113 measured at five points at an equal distance in the upper portion or the lower portion of the capacitance formation portion Ac.

Also, the margin portions 114 and 115 may be disposed on side surfaces of the capacitance formation portion Ac.

The margin portions 114 and 115 may include a first margin portion 114 disposed on the fifth surface 5 of the body 110 and a second margin portion 115 disposed on the sixth surface 6. That is, the margin portions 114 and 115 may be disposed on both end surfaces of the ceramic body 110 in the width direction.

The margin portions 114 and 115 may indicate a region between both ends of the first and second internal electrodes 121 and 122 and the boundary surface of the body 110 in a cross-section in the width-thickness (W-T) direction of the body 110 as illustrated in FIG. 5.

The margin portions 114 and 115 may basically prevent damages to the internal electrode due to physical or chemical stress.

The margin portions 114 and 115 may be formed by forming an internal electrode by applying a conductive paste on the ceramic green sheet other than the region in which the margin portion is to be formed.

Also, to prevent a step difference caused by the internal electrodes 121 and 122, after laminating, the margin portion 114 and 115 may be formed by cutting the internal electrode to be exposed to the fifth and sixth surfaces 5 and 6 of the body, and laminating a single dielectric layer or two or more dielectric layers on both side surfaces of the capacitance formation portion Ac in the third direction (width direction).

Widths of the margin portions 114 and 115 may not be limited to any particular example. The average width of the margin portions 114 and 115 may be 100 μm or less.

The average width of margin portions 114 and 115 may be the average size MW1 in the third direction of the region in which the internal electrode is spaced apart from the fifth surface and the average size MW2 in the third direction of the region in which the internal electrode is spaced apart from the sixth surface, and may be the average value of the sizes in the third direction of the margin portions 114 and 115 measured at five points at an equal distance on the side surface of the capacitance formation portion Ac.

Accordingly, in an embodiment, each of the average sizes MW1 and MW2 in the third direction of the region spaced apart from the fifth and sixth surfaces of the internal electrodes 121 and 122 may be 100 μm or less.

The internal electrodes 121 and 122 may include first and second internal electrodes 121 and 122. The first and second internal electrodes 121 and 122 may be alternately disposed to oppose each other with the dielectric layer 111 included in the body 110 therebetween, and may be exposed to the third and fourth surfaces 3 and 4 of the body 110, respectively.

The first internal electrode 121 may be spaced apart from the fourth surface 4 and may be exposed through the third surface 3, and the second internal electrode 122 may be spaced apart from the third surface 3 and may be exposed through the fourth surface 4. Also, the first external electrode 131 may be disposed on the third surface 3 of the body and may be connected to the first internal electrode 121, and the second external electrode 132 may be disposed on the fourth surface 4 of the body and the be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be spaced apart from the fourth surface 4 at a predetermined distance, and the second internal electrode 122 may be spaced apart from the third surface 3 by a predetermined distance. Also, the first and second internal electrodes 121 and 122 may be spaced apart from the fifth and sixth surfaces of the body 110.

A conductive metal included in the internal electrodes 121 and 122 may include one or more selected from the group consisting of Ni, Cu, Pd, Ag, Au, Pt, In, Sn, Al, Ti and alloys thereof, but an embodiment thereof is not limited thereto.

The average thickness the of the internal electrode may not be specifically limited. In this case, the thickness of the internal electrodes 121 and 122 may indicate the size in the first direction of the internal electrodes 121 and 122.

However, to easily implement miniaturization and high capacitance of multilayer electronic component, the average thickness of the internal electrodes 121 and 122 may be 0.4 μm or less.

The average thickness the of the internal electrodes 121 and 122 may be measured by scanning the cross-sectional surface in the first and second directions of the body 110 with a scanning electron microscope (SEM) at 10,000× magnification. More specifically, the thickness may be measured at multiple points of one of the internal electrodes 121 and 122, for example, 30 points at equal distances in the second direction, and the average value may be measured. The 30 points at equal distances may be designated as the capacitance formation portion Ac. Also, by measuring the average value of 10 internal electrodes 121 and 122, the average thickness of the internal electrodes 121 and 122 may be further generalized.

The external electrodes 131 and 132 may be disposed on the third and fourth surfaces 3 and 4 of the body 110.

The external electrodes 131 and 132 may be disposed on the third and fourth surfaces 3 and 4 of the body 110, respectively, and may include the first and second external electrodes 131 and 132 connected to the first and second internal electrodes 121 and 122, respectively.

Referring to FIG. 1, external electrodes 131 and 132 may be disposed to cover both cross-sectional surfaces of the second direction side margin portions 114 and 115.

In the embodiment, the multilayer electronic component 100 may have two external electrodes 131 and 132, but the number of the external electrodes 131 and 132 or the shape thereof may be varied depending on the shape of the internal electrodes 121 and 122 or other purposes.

The external electrodes 131 and 132 may be formed of any material having electrical conductivity, such as metal, and a specific material may be determined in consideration of electrical properties and structural stability, and the external electrodes 131 and 132 may have a multilayer structure.

For example, the external electrodes 131 and 132 may include electrode layers 131a and 132a disposed on the body 110 and plating layers 131b and 132b disposed on the electrode layer.

For a more specific example of the electrode layers 131a and 132a, the electrode layers 131a and 132a may be firing electrodes including a conductive metal and glass, or resin electrodes including a conductive metal and resin.

Also, in the electrode layers 131a and 132a, a firing electrode and a resin electrode may be formed in this order on the body. Also, the electrode layers 131a and 132a may be formed by transferring a sheet including a conductive metal to the body, or may be formed by transferring a sheet including a conductive metal to the firing electrode.

A material having excellent electrical conductivity may be used as the conductive metal included in the electrode layers 131a and 132a, and is not limited to any particular example. For example, the conductive metal may include one or more selected from the group consisting of nickel (Ni), copper (Cu), and alloys thereof.

The plating layers 131b and 132b may improve mounting properties. The type of the plating layers 131b and 132b is not limited to any particular example, and may be a plating layer including one or more of Ni, Sn, Pd, and alloys thereof, and may be formed as a plurality of layers.

For a more specific example of the plating layers 131b and 132b, the plating layers 131b and 132b may be Ni plating layers or Sn plating layers, and Ni plating layers and Sn plating layers may be formed in order on the electrode layers 131a and 132a, or Sn plating layers, Ni plating layers, and Sn plating layers may be formed in order. Also, the plating layers 131b and 132b may include a plurality of Ni plating layers and/or a plurality of Sn plating layers.

The size of the ceramic electronic component 100 may not be limited to any particular example. For example, the size of the multilayer electronic component 100 may be 0201 (length×width, 0.2 mm×0.1 mm), 0603 (length×width, 0.6 mm×0.3 mm), 1005 (length×width, 1.0 mm×0.5 mm), 2012 (length×width, 2.0 mm×1.2 mm), 3216 (length×width, 3.2 mm×1.6 mm), 3225 (length×width, 3.2 mm×2.5 mm), or the like.

### Method of Manufacturing Multilayer Electronic Components

Hereinafter, an example of a method of manufacturing the multilayer electronic component 100 according to an embodiment of the present disclosure will be described. However, the method of manufacturing the multilayer electronic component 100 in the embodiment is not limited thereto.

First, by applying a ceramic slurry including ceramic powder, an organic solvent, and a binder onto a carrier film, a ceramic green sheet may be formed. The ceramic green sheet may be manufactured by configuring the interfacial portion of the ceramic sheet to have a higher Gd content than that of the central portion.

Thereafter, an internal electrode pattern may be formed by printing a conductive paste for internal electrodes including metal powder, a binder, an organic solvent, or the like, onto the ceramic green sheet at a predetermined thickness using a screen printing method or a gravure printing method, thereby manufacturing a ceramic green sheet for the capacitance formation portion.

By laminating the ceramic green sheet for the capacitance formation portion in the X direction, a laminate may be obtained. In this case, a ceramic green sheet on which an internal electrode pattern is not formed may be laminated on the upper and lower portions of the laminate to form cover portions 112 and 113 after sintering.

The laminate may be cut to a predetermined chip size. In this case, the ends of the internal electrode patterns may be exposed on both surfaces facing in the third direction of the cut chip.

Thereafter, a sheet for forming the margin portion may be attached to both surfaces facing in the third direction of the cut-out chip and may be fired, thereby forming the body 110 and the side margin portions 114 and 115. The firing temperature may be, for example, 1000° C. or higher and 1400° C. or lower, but an embodiment thereof is not limited thereto.

The sheet for forming the margin portion is not limited to any particular example, and the general ceramic green sheet described above may be used.

Thereafter, external electrodes 131 and 132 may be formed. For example, when the base electrode layers 131a and 132a include a firing electrode layer, the body 110 may be dipped in a conductive paste for an external electrode including metal powder, glass frit, a binder, and an organic solvent, and may be fired at a temperature of 500° C. to 900° C., thereby forming a firing electrode layer.

For example, when the base electrode layers 131a and 132a include a resin electrode layer, the body may be dipped in a conductive resin composition including metal powder, resin, a binder, and an organic solvent, and may be cured and heat-treated at a temperature of 250° C. to 550° C., thereby forming a resin electrode layer.

Also, by additionally performing an electrolytic plating method and/or an electroless plating method, the plating layers 131b and 132b may be formed on the base electrode layers 131a and 132a.

### Experimental Example

A sample chip of 1005 size (length: approximately 1.0 mm, width: approximately 0.5 mm, thickness: approximately 0.5 mm) was prepared using the manufacturing method described above.

The sample chip was manufactured such that the average size Gs1 of the first dielectric grain, the average size Gs2 of the second dielectric grain, the number of moles Mgd1 of Gd based on 100 moles of Ti in the central portion, and the number of moles Mgd2 of Gd based on 100 moles of Ti in the interfacial portion satisfied the values in Table 1 below.

The average size of the first dielectric grain, Gs1, the average size of the second dielectric grain, Gs2, the number of moles of Gd per 100 moles of Ti in the central portion, Mgd1, and the number of moles of Gd per 100 moles of Ti in the interfacial portion were measured by analyzing the cross-sectional surfaces in the first and second direction of the sample chip, polished to the ½ point in the third direction, using FE-SEM-EDS (acceleration voltage: 2 kV, magnification: 50,000×).

The capacitance of the sample chip was measured at 1 kHz using an LCR meter, and the relative values are listed in Table 1 below.

Also, as for moisture resistance reliability, the sample chip was mounted on the substrate, and by applying a high voltage of 1 kV for 1000 hours at a temperature of 85° C. and a relative humidity of 85%. When the insulation resistance decreased to 1/100 or less as compared to the initial value, it was marked as ‘X,’ and when the insulation resistance remained at higher than 1/100 as compared to the initial value, it was marked as ‘o.’ In the case of ‘X’ it may be determined that cracks occurred due t electrostriction and the electrostrain suppression effect was insufficient, and in the case of ‘o,’ it may be determined that electrostriction was suppressed and cracks did not occur, and the electrostrain suppression effect was excellent.

TABLE 1

| | Sample No. | | | | | | |
|---|---|---|---|---|---|---|---|
| | 1 | 2 | 3 | 4 | 5 | 6 | 7 |
| Gs1 | 480 | 480 | 450 | 480 | 475 | 475 | 440 |
| Gs2 | 480 | 450 | 450 | 390 | 380 | 200 | 450 |
| Mgd1 | 0 | 0 | 2.0 | 0.0 | 1.0 | 1.0 | 4.0 |
| Mgd2 | 0 | 2.0 | 2.0 | 7.0 | 10.0 | 28.0 | 2.0 |
| Capac- | 106.34 | 104.08 | 102.02 | 100.0 | 98.8 | 96.05 | 85.05 |
| itance | | | | | | | |
| (%) | | | | | | | |
| Moisture | X | X | X | ◯ | ◯ | ◯ | ◯ |
| resistance | | | | | | | |
| reliability | | | | | | | |

Referring to Table 1, sample No. 1, in which Mgd1 and Mgd2 were 0, exhibited the best capacitance, but moisture resistance reliability was deteriorated. Samples No. 2 and 3, which contained small amounts of Gd, also exhibited deteriorated moisture resistance reliability. Samples No. 6 and 7 exhibited degraded capacitance due to the high amount of Gd added.

Samples No. 4 and 5, which satisfied the entirety of the conditions Gs2/Gs1<1, Mgd1/Mgd2<1, and 4.0≤Mgd2≤25.0, capacitance degradation was suppressed, and moisture resistance reliability was excellent.

According to the aforementioned embodiments, by controlling the dielectric grain average size and the Gd content of the interfacial portion and the central portion of the dielectric layer, reliability of multilayer electronic components may be improved.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment.

The above suggested embodiments may be implemented do not exclude the possibilities of combination with features of other embodiments. For example, even though the features described in an embodiment are not described in the other embodiment, the description may be understood as relevant to the other embodiment unless otherwise indicated.

An expression used in the singular encompasses the expression of the plural, unless it has a clearly different meaning in the context.

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer and internal electrodes alternately disposed with the dielectric layer; and
external electrodes disposed on the body,
wherein the dielectric layer includes a central portion spaced apart from the internal electrode and including a first dielectric grain, and interfacial portions disposed between the internal electrode and the central portion and including a second dielectric grain, and
wherein an average size of the first dielectric grain is Gs1, an average size of the second dielectric grain is Gs2, a number of moles of Gd based on 100 moles of Ti in the central portion is Mgd1, and a number of moles of Gd based on 100 moles of Ti in the interfacial portion is Mgd2,
Gs2/Gs1<1, Mgd1/Mgd2<1, and 4.0≤Mgd2≤25.0 are satisfied.

2. The multilayer electronic component of claim 1, wherein Gs1 and Gs2 satisfy Gs2/Gs1≥0.5.

3. The multilayer electronic component of claim 1,
wherein Gs1 is 300 nm or more and 700 nm or less, and
wherein Gs2 is 150 nm or more and 600 nm or less.

4. The multilayer electronic component of claim 1,
wherein Gs1 and Gs2 satisfy Gs1−Gs2≤100 nm.

5. The multilayer electronic component of claim 1,
wherein Mgd2 satisfies 5.0≤Mgd2≤10.0.

6. The multilayer electronic component of claim 1, wherein Mgd1 is 0.

7. The multilayer electronic component of claim 1,
wherein the internal electrode includes first and second internal electrodes alternately disposed with the dielectric layer therebetween, and
wherein the interfacial portion includes a first interfacial portion disposed between the central portion and the first internal electrode, and a second interfacial portion disposed between the central portion and the second internal electrode.

8. The multilayer electronic component of claim 7, wherein, when an average thickness of the first interfacial portion is tdi1, an average thickness of the second interfacial portion is tdi2, and an average thickness of the central portion is tdc, tdi1/tdc≤0.2 and tdi2/tdc≤0.2 are satisfied.

9. The multilayer electronic component of claim 8, wherein tdi1 and tdi2 are 200 nm or more and 500 nm or less, respectively.

10. The multilayer electronic component of claim 8, wherein tdc is 1000 nm or more.

11. The multilayer electronic component of claim 8, wherein a sum of tdi1, tdi2 and tdc is 1.4 μm or more and 10.0 μm or less.

12. The multilayer electronic component of claim 1, wherein the dielectric layer includes one or more selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) and Ba(Ti_{1-y}Zr_{y})O₃ (0<y<1) as a main component.

13. The multilayer electronic component of claim 1, wherein a dielectric constant of the interfacial portion is 1500 or less, and a dielectric constant of the central portion is 2000 or more.

14. The multilayer electronic component of claim 1, wherein at least one of the second dielectric grain has a core-shell structure.

15. The multilayer electronic component of claim 14, wherein at least one of the first dielectric grain has a core-shell structure.
